(19) United States
(12) Patent Application Publication
(10) Pub. No.: US 2006/0190974 A1
(43) Pub. Date: Aug. 24, 2006

(54) Home network system and method for transmitting contents thereof

(75) Inventor: Sung-jin Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/280,171

(22) Filed: Nov. 17, 2005

(30) Foreign Application Priority Data
Feb. 22, 2005 (KR) 2005-14548

(51) Int. Cl. H04N 7/173

(52) U.S. Cl. 725/87; 725/86; 725/109; 725/110; 725/112; 725/113

(57) ABSTRACT

Disclosed are a home network system and a contents transmission method for a home network system, wherein the home network system includes: a Video On Demand (VOD) server for providing a VOD contents service and converting the contents to be suited for at least one device at home; a home server being connected to the VOD server and tracking the user's location for managing a context which is situation information on the user's location and the user's location movement associated with the device close to the user among the at least one device; and an internal communication device identifying the device for networking the home server and the at least one device. In accordance with the present invention, since contents are transmitted after being converted so as to be suitable to a device, it is possible to increase job efficiency in a home network system.

### CROSS-REFERENCE TO RELATED APPLICATIONS

This application claims benefit under 35 U.S.C. § 119 from Korean Patent Application No. 2005-14548, filed on Feb. 22, 2005, the entire content of which is incorporated herein by reference.

### BACKGROUND OF THE INVENTION

1. Field of the Invention

The present invention relates to a home network system and method for transmitting contents thereof. More specifically, the present invention relates to a home network system and method for transmitting contents thereof that tracks the user's location to transmit the contents suited for a device in the moved user's location.

2. Description of the Related Art

In general, a home network system means a network system that is capable of performing an intelligent communication by performing a network matching between a home network installed at home and an external communication network. As a result, the share of information resources at home and the efficiency of any individual products will be maximized through such a networking.

Home devices constituting a home network include an information device such as personal computers, facsimile machines, scanners, and printers, etc., a control device such as TVs, set-top boxes, DVDs, VCRs, audios, camcorders, and home game machines, etc., and a dummy device such as remote controllers, interphones, sensors, and light source units, etc. Such home devices are connect to a sub-network such as a telephone line, a wireless LAN, a Bluetooth, a Universal Serial Bus (USB), IEEE 1394, or a power line depending on their categories, respectively.

Meanwhile, a system for automatically controlling the home devices based on the user's location has been proposed. FIG. 1 is a conceptual diagram showing one conventional user's location-based exemplary home network system.

Referring to FIG. 1, in a conventional home network system, a home server 30 plays a role of a gateway connecting the inner of home with an external Video On Demand (VOD) server 10 through an Internet 20.

For example, when the user's location is moved from a first device 50 to a second device 60 (in case of ‘I’), the home server 30 tracks the user's location using a location sensor 40 and performs trans-coding and trans-rating with respect to the contents so as for the contents to be suited for the characteristic of the second device 60. Here, the trans-coding means the change of compression scheme and the trans-rating means the change of transmission rate.

The home server 30 changes the transmission location of the contents trans-coded or trans-rated and transmits to the second device 60.

The home server 30 becomes a client of the VOD server 10 to receive the contents, the home server 30 receives various data from the VOD server 10 in real time and simultaneously performs the trans-coding/trans-rating. The home server 30 may suffer from overload upon performing the trans-coding/trans-rating, since it performs such several operations at a time. In particular, the home sever can suffer from overload enough for the adverse affect on other services in case of performing such operations in a software manner.

In addition, even when the user's location is moved from the first device 50 having the transmission rate of 4 Mbps (Mega bit per second) for MPEG 2 to a third device 70 having the transmission rate of 1 Mbps for MPEG 4 (in case of “II), the compression rate and the compression scheme of the contents transmitted from the VOD server 10 to the home server are always identical and thus, the bandwidth occupying the network between the VOD server 10 and the home server is identical.

As a result, it has problems that the delay is caused for receiving an incoming service through the home server 30 and the quality of service is poor.

### SUMMARY OF THE INVENTION

It is a feature of the invention to provide a home network system and method for transmitting contents thereof capable of converting and transmitting the contents to be suited for a device in the moved user's location.

In order to overcome the problems described above, the home network system of the present invention includes a Video On Demand (VOD) server providing a VOD contents service and converting the contents to be suited for at least one device at home; a home server connecting to the VOD server, and tracking the user's location for managing a context, wherein the context is situation information on the user's location and the user's location movement associated with the device close to the user among the at least one device; and an internal communication device identifying the device for networking the home server and the at least one device.

The VOD server converts the contents by the trans-coding converting the compression scheme or the trans-rating converting the transmission rate, in order to make it suited for the context.

The VOD server converts the contents when the home server requests the conversion of the contents.

The home server includes a profile manager managing the profile of the at least one device; a context-aware processor managing the context associated with the user's location and the user's location movement, among the at least one device; and a contents adaptation agent requesting the conversion of the contents to be suited for the device close to the user, based on the context managed by the context-aware processing portion.

The profile manager includes a profile status checker determining whether the profile of device close to the user should be updated; a profile registration portion registering or updating the profile of the device as the determination of the profile status checker; and a profile repository portion storing the profile of the device registered and updated in the profile registration portion.

The context-aware processor includes a context aggregator aggregating the context; a context DB storing portion storing the context aggregated by the context aggregator; a context interpreter interpreting the context aggregated from the context aggregator and comparing it using the context stored in the context DB storing portion; and a context service provider selecting the device to be provided with the context service using the information interpreted by the context interpreter in order to receive the contents converted and extracting the characteristic of the corresponding device.

The contents adaptation agent includes a device list storing portion storing the profile of the at least one device or a list associated with the context; a device manager determining whether the device close to the user requires the context service, in order to receive the converted contents based on the list stored in the device list storing portion; a request client function portion requesting the VOD server to convert the contents to be suited for the device close to the user; and a forwarding processor transmitting the contents converted depending on the request of the request client function portion to a target device that will receive the context service.

The contents adaptation agent further includes a location tracking sensor for tracking the user's location.

Meanwhile, a method of the home network according to the invention includes the steps of: (a) requesting the conversion of contents to be suited for a device close to a user, by tracking the user's location for managing a context, wherein the context is situation information on the user's location and the user's location movement associated with the device close to the user among the at least one device; (b) converting the contents depending on the converting request of the contents; (c) transmitting the converted contents to the device close to the user.

The step (a) includes further includes the steps of: tracking the user's location and checking the profile status of the device close to the user, among at least one device at home; determining whether the profile of the device close to the user is registered; when the profile of the device is not registered, newly registering the profile of the device; and when the profile of the device is registered but is required to update, registering the updated profile.

The step (a) includes further includes the steps of: aggregating the context; interpreting the context aggregated by comparing it with the context stored previously; and selecting a target device that will receive the converted contents, using the interpreted context and extracting the characteristic value of the target device.

The step (a) includes further includes the step of determining whether the context service is needed.

### BRIEF DESCRIPTION OF THE DRAWINGS

FIG. 1 is a concept diagram showing one example of the conventional user's location-based home network system;

FIG. 2 is a concept diagram showing a home network system according to one embodiment of the present invention;

FIG. 3 is a block diagram for explaining the constitution of a home server shown in FIG. 2;

FIG. 4 is a graph showing the increase of transmission bandwidth available in the home network system according to the present invention;

FIG. 5 is a flowchart showing a method of controlling the contents transmission using the home network in FIG. 2; and

FIG. 6 is a flowchart showing method shown in FIG. 5 in more detail.

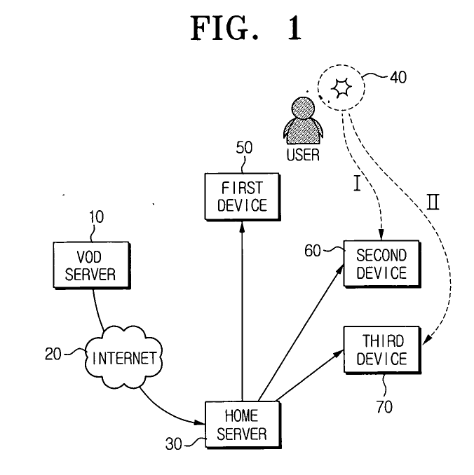

### DETAILED DESCRIPTION OF THE EXEMPLARY EMBODIMENTS

Referring now to the appended drawings, the preferable embodiments according to the present invention will be explained in detail below. However, in explaining the present invention, if the concrete explanation for known functions or constitutions makes the subject of the present invention obscure, the explanation thereon will be omitted.

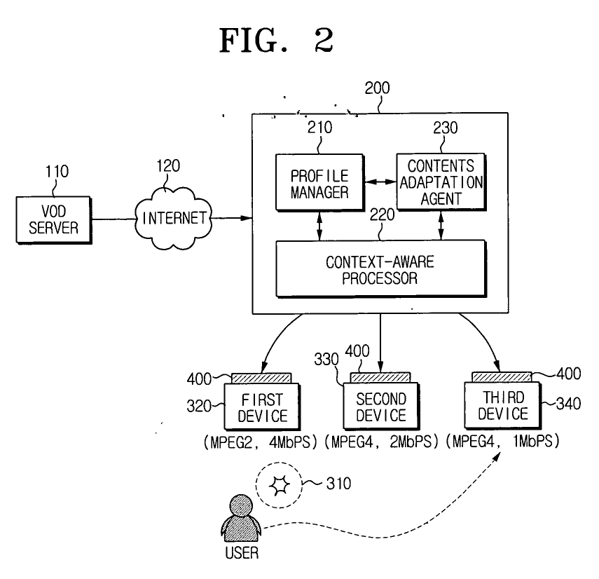

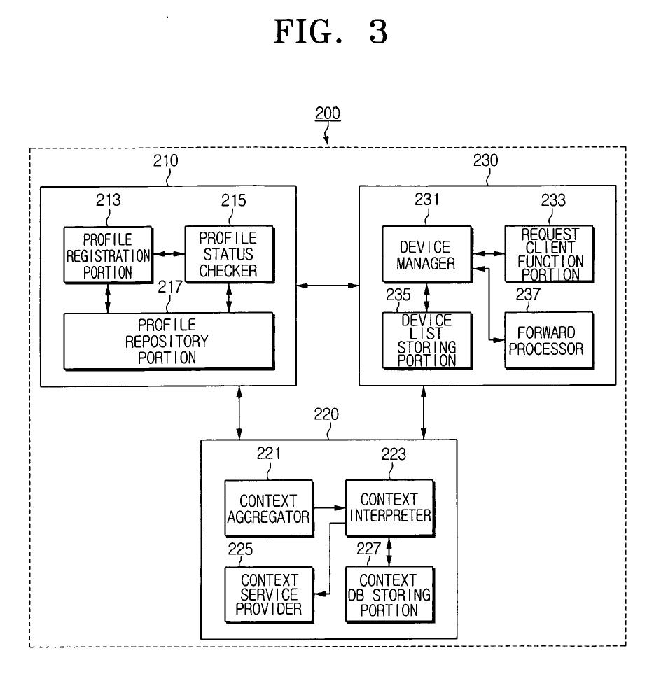

FIG. 2 is a concept diagram showing a home network system according to one embodiment of the present invention, and FIG. 3 is a block diagram for explaining the constitution of a home server shown in FIG. 2.

Referring to FIG. 2 and FIG. 3, in the home network system according to the present invention, the home server 200 senses the user's location movement halfway and simultaneously, manages a VOD contents stream service by a VOD server 110 through an Internet 120. The VOD contents stream service means a service capable of receiving desired contents through a computer or TV connected by the communication network.

The home server 200 integrally manages and controls first to third devices 320, 330, 340 at home. An internal communication device 400 is required to notify the home server 200 of the information such as the type and the operation status of each of the first to third devices 320, 330, 340, etc., and receive a control signal from the home server 200.

Each one of the internal communication devices 400 is installed to the first to third devices 320, 330, 340, respectively, and thus, has an each inherent identification code for identifying each device and broadcasts the identification code at regular intervals.

The inherent identification code generated in the internal communication device 400 is consisted of the information on the type capable of identifying which type of device it corresponds to the inherent code artificially provided by a person and the status information notifying the operation status of the device, and the like. Of course, such information can include the manufacturing company of the device, product information, version information, etc.

The method for networking the home server 300 and the internal communication device 400 includes a method using a laser light, a method using Radio Frequency (RF), a method using a power line, a wired/wireless LAN, or Bluetooth, etc.

In case of using the laser light, the internal communication device 400 is a device receiving the laser light as a signal and correspondingly, the home server 200 is provided with a light receiving device receiving and decoding the laser light signal and a light emitting device emitting the laser light signal. In case of the RF signal, the internal communication device 400 is a device transmitting the RF and correspondingly, the home server 200 is provided with an antenna and a signal processor capable of receiving and decoding the RF signal and a transmission device transmitting the RF signal.

In case of using the power line, the internal communication device 400 is a Power Line Communication (PLC) chip capable of making the power line communication and correspondingly, the power line communication signal flowing inside the home server 200 or between the home server 200 and the internal communication device (400) is separated from a power supply voltage and the separated communication signal is decoded by the power line communication protocol, i.e., Z256 and the home server 200 is provided with the power line signal processing device transmitting to the internal communication device 400. In case of using the wired/wireless LAN and the Bluetooth, the internal communication device 400 corresponds to a modem included in each device itself.

Meanwhile, as shown in FIG. 2, when the user's location is moved from the first device 320 using 4 Mbps for MPEG 2 to the third device 340 using 1 Mbps for MPEG 4, corresponding to the compression scheme and the transmission rate, respectively, the home server 200 senses the fact that the user's location is moved through the location sensor (310).

What the home server 200 senses the fact that the user's location is moved is determined by a co-operative action between a location sensing device (not shown) installed inside the home and the location sensor 310 attached to the user.

The home server 200 receives the fact that the user's location is moved and the characteristic of the third device moved 340 and requests the VOD server 110 to convert its own contents into the 1 Mbps contents of the MPEG 4 corresponding to the compression scheme and the transmission rate of the third device 340.

The VOD server 110 has various contents formats and is excellent in performance over the home server 200. As a result, it can prevent overload phenomenon being caused upon performing the trans-coding/trans-rating in the home server 200 and enhance the work efficiency by preventing the waste of the transmission bandwidth of the network required for transmitting the contents.

The home server 200 includes a profile manager 210, a contents adaptation agent 230, and a context-aware processor 220.

As the profile manager 210 is a portion managing so that the device in the home network system has any characteristic, it registers and manages a device to be added newly and manages the profile of the device. For example, the profile manager 210 can use a technology such as UPnP.

The profile manager 210 includes a profile registration portion 213, a profile status checker 215, and a profile repository portion 217.

The profile registration portion 213 checks the device in which the user is now located, among the first to third devices 320, 330, and 340 and then checks whether the device is registered previously, and thereby, when the device is not registered, newly registers the profile of the corresponding device.

The profile registration portion 213 checks whether the corresponding device is registered and stored among the profiles of the devices stored in the profile repository portion 217 as will be described below, and thereby, when the corresponding device is not registered, newly registers the profile of the corresponding device and stores it in the profile repository portion 217.

Although the device is already registered among the first to third devices 320, 33, 340, the profile status checker 215 checks the profile of the device.

When determining as corresponding to the case to be required for updating by the profile status checker 215, the profile registration portion 213 updates the profile of the corresponding device. As examples of the case to be required to update for the profile of the device may include the case that the firmware of the device is updated to make the change in status associated with the corresponding device, such as the change in capability of the device, etc.

The profile status checker 215 compares the profile status of the device stored in the profile repository portion 217 with the profile status of the corresponding device using question and answer through a query and then determines whether to update.

The profile repository portion 217 is a portion storing the information on the profile of the device required to be shared in the home server 200. Of course, it stores the profile of the device registered by the profile registration portion 213 as well as the profile of the device updated and registered by the profile registration portion 213.

The context-aware processor 220 plays a role of processing the situation information on the user's current location and the user's location movement, i.e., the context and interpreting the situations of the user and the device, etc., and plays a role of selecting the corresponding device to be processed based on the interpreted information and extracting the characteristic value of the corresponding device.

The method for sensing the user's current location and the user's location movement can consider several methods for sensing and determining the user's location by installing an infrared sensor, etc., as a sensor for sensing the human body in the devices at home or obtaining the user's location signals from the user image photographed directly by the camera.

The context-aware processor 220 includes a context aggregator 221, a context interpreter 223, a context service provider 225 and a context DB storing portion 227.

The context aggregator 221 is a portion aggregating the context associated with the user's location and the device in which the user is now located. In the home network system according to the present invention, the context aggregator is an important component since the user's location information is important information.

The context interpreter 223 is a portion interpreting the information aggregated by the context aggregator 221 and the context DB storing portion 227 is a portion storing a database about the device context.

The context interpreter 223 compares and checks the interpreted information with the context associated with the device stored in the context DB storing portion 227 by mutually answering with the context DB storing portion 227.

The context service provider 225 selects and determines the target device that will receive a service (Hereinafter referred to as a context service), using the information comparing and checking the context by the context interpreter 223, wherein the service can allow the target device to receive the contents converted to be suited for the situation according to the present invention, and extracts the characteristic value of the target device.

The contents adaptation agent 230 requests the contents for the device to the VOD server 110 and determines whether the contents is transmitted to which device of the first to third devices 320, 330, 340. The contents adaptation agent 230 includes, as a portion playing a role of coordinating, a device manager 231, a request client function portion 233, a device list storing portion 235, and a forwarding processor 237.

The device manager 231 determines whether the context service according to the present invention is needed, using the information extracted by the context service provider 225 in the context-aware processor 220.

That is, when the user is located in the device having the same compression rate/transmission rate as those of the contents which is supported from the VOD server 110, the context service depending on the present invention is not required.

When the user is located in the device requiring the context service, the request client function portion 233 is a portion requesting the VOD server to convert the contents to be suited for the characteristic of the corresponding device.

That is, when the user's location is moved, the request client function portion 233 requests the VOD server 110 to convert the contents to be suited for the characteristic of the corresponding device in real time, in order to manage the target device to which the context service is provided.

When the user moves from the first device 320 to the third device 340, the VOD server 110 is requested to convert the contents to be suited for the characteristic of the third device, in order to manage the third device 340 in which the user is now located, based on the user's location. In other words, the VOD server 110 is requested to convert the contents corresponding to 4 Mbps of MPEG 2 for the first device 320 into the contents corresponding to 1 Mbps of MPEG 4 for the third device 340.

The device list storing portion 235 stores the list for the target device in which the user is now located through his location movement. The list for the device can be DB including the associated context.

The forwarding processor 237 receives the contents converted by the VOD server 110 and exactly transmits to the third device 340, which is the target device to which the context service is provided.

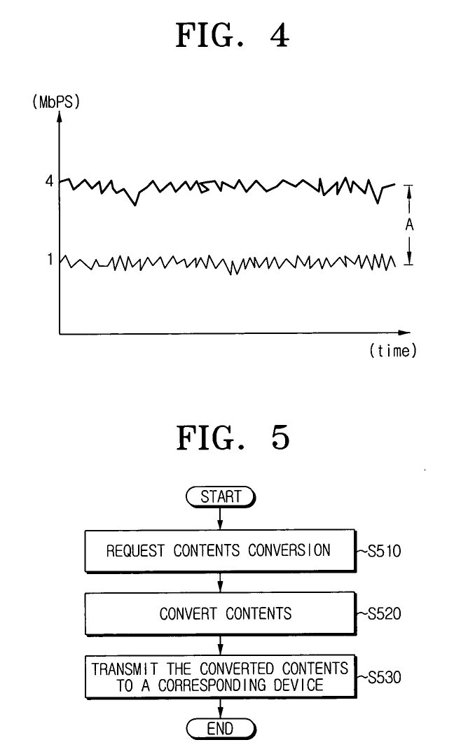

FIG. 4 is a graph showing the increase of transmission bandwidth available in the home network system according to the present invention.

Referring to FIG. 4, as described in FIG. 2, when the contents corresponding to 4 Mbps of MPEG 2 for the first device 320 is converted into the contents corresponding to 1 Mbps of MPEG 4 for the third device 340, the available bandwidth is increased by 3 Mbps corresponding to ‘A’. The increase of the transmission bandwidth available enhances the work efficiency of service performed within the home network system.

FIG. 5 is a flowchart showing a method for adjusting the contents transmission using the home network in FIG. 2.

Referring to FIGS. 2 to 5, in S510, the VOD server 110 is requested to track the user's location by the home server 200 for managing the context associated with the third device to which the user is moved, among the first to third devices 320, 330, 340, thereby converting the contents to be suited for the third device 340.

Next, in S520, the VOD server 110 converts the contents to be suited for the third device 340, depending on the contents conversion request by the home server 200.

The home server 200 exactly forwards (i.e., transmits) the contents converted by the VOD server 110 to the third device 340.

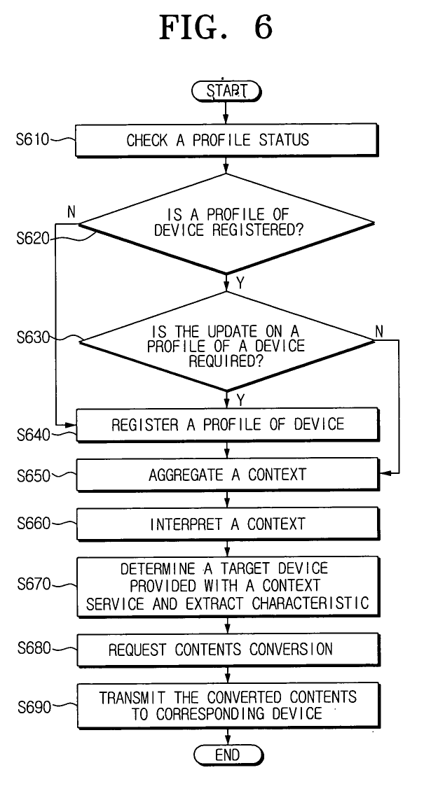

FIG. 6 is a flowchart showing for concretely explaining the method shown in FIG. 5.

Referring to FIGS. 2 to 6, when the user's location is moved from the first device 320 to the third device 340, the profile status checker 215 first check the user's current location and the profile status of the third device 340 in S610. The profile status checkers 215 compares the profile status of the device stored previously in the profile repository portion 217 with the profile status of the third device 340 using question and answer through a query and then determines whether to register.

If the third device 340 is not now registered in the profile repository portion 217 in S620 (NO), the profile of the third device 340 is newly registered in S 640. The profile of the third device 340 is registered and stored in the profile repository portion 217.

Although the third device 340 is already registered in the profile repository portion 217, the profile of the device is checked by the profile status checker 215 to determine whether to update in S630.

If the update of the profile is needed due to the change in situation associated with the third device 340, etc., in S630 (YES), the profile of the third device 340 updated newly is registered in the profile repository portion 217 by the profile registration portion 213 in S640.

The context registered previously in the profile repository portion 217 and the context registered newly for the third device 340 are aggregated by the context aggregator 221 in S650. The context means the situation information on the user's location and the user's location movement.

The aggregated context is interpreted by the context interpreter 223 in S660. The interpreted information is compared and checked with the context associated with the device which is stored in the context DB storing portion 227, by the context interpreter 223. The comparing and checking processes by the context interpreter 223 can be performed using question and answer through a query on the context DB storing portion 227.

The context service provider 225 selects and determines the device to be provided with the context service according to the present invention and extracts the characteristic of the target device, in S670. That is, it selects the target device that will receive the context service, using the context information compared and checked by the context interpreter 223 and extracts the characteristic of the target device.

The request client function portion 233 requests the VOD server 110 to convert the contents to be suited for the characteristic of the device requiring the context service in which the user is located, in S680. In other words, if the compression scheme and the transmission rate the contents supported by the VOD server 110 are different from the compression scheme and the transmission rate the contents required by the target device, it requests the change of the contents to be suited for the characteristic of the device.

The forwarding processor 237 transmits the changed contents to the target device, using the device list stored in the device list storing portion 235, in S690.

As a result, it can prevent overload capable of being caused at the server in the home network system and enhance the work efficiency by preventing the waste of the transmission bandwidth of the contents.

As described above, according to the present invention, it can prevent overload capable of being caused at the server in the home network system, by tracking the user's location for converting the contents provided to be suited for the device in which the user is located.

In addition, it can enhance the work efficiency of the home network system by providing the contents suited for the device in which the user is located and thus, efficiently use 'the transmission bandwidth of the contents.

As above, the concrete embodiments have been described in the detailed description of the present invention, however, various modifications may be implemented with respect to the foregoing description without departing from the scope of the present invention. Thus, the present invention is not limited to the particular embodiments described herein, but rather is limited only by the following claims and their equivalents.

What is claimed is:

1. A home network system, comprising:
a Video On Demand (VOD) server for providing a VOD contents service and converting the contents to be suited for at least one device at home;
a home server connected to the VOD server for tracking the user's location and managing a context which is situation information on the user's location and the user's location movement associated with the device close to the user among the at least one device; and
an internal communication device identifying the device for networking the home server and the at least one device.

2. The home system according to claim 1, wherein the VOD server converts the contents by the trans-coding method which converts a compression scheme or the trans-rating which converts a transmission rate, in order to make it be suited for the context.

3. The home system according to claim 1, wherein the VOD server converts the contents when the home server requests the conversion of the contents.

4. The home system according to claim 1, wherein the home server includes:
a profile manager managing the profile of the at least one device;
a context-aware processor managing the context associated with the user's location and the user's location movement among the at least one device; and
a contents adaptation agent requesting the conversion of the contents to be suited for the device close to the user, based on the context managed by the context-aware processing portion.

5. The home system according to claim 4, wherein the profile manager includes:
a profile status checker determining whether the profile of device close to the user should be updated;
a profile registration portion registering or updating the profile of the device as the determination of the profile status checker; and
a profile repository portion storing the profile of the device registered and updated in the profile registration portion.

6. The home system according to claim 4, wherein the context-aware processor includes:
a context aggregator aggregating the context;
a context DB storing portion storing the context aggregated by the context aggregator;
a context interpreter interpreting the context aggregated from the context aggregator and comparing it using the context stored in the context DB storing portion; and
a context service provider selecting the device to be provided with the context service using the information interpreted by the context interpreter in order to receive the contents converted and extracting the characteristic of the corresponding device.

7. The home system according to claim 4, wherein the contents adaptation agent includes:
a device list storing portion storing the profile of the at least one device or a list associated with the context;
a device manager determining whether the device close to the user requires the context service, in order to receive the converted contents based on the list stored in the device list storing portion;
a request client function portion requesting the VOD server to convert the contents to be suited for the device close to the user; and
a forwarding processor transmitting the contents converted depending on the request of the request client function portion to a target device that will receive the context service.

8. The home system according to claim 1, wherein the contents adaptation agent further includes a location tracking sensor for tracking the user's location.

9. A method of the home network, comprising the steps of:
(a) requesting the conversion of contents to be suited for a device close to a user, by tracking the user's location for managing a context, wherein the context is situation information on the user's location and the user's location movement associated with the device close to the user among the at least one device;
(b) converting the contents depending on the converting request of the contents; and
(c) transmitting the converted contents to the device close to the user.

10. The method according to claim 9, wherein the step (a) includes:
tracking the user's location and checking the profile status of the device close to the user, among at least one device at home;
determining whether the profile of the device close to the user is registered;
newly registering the profile of the device when the profile of the device is not registered; and
registering the updated profile when the profile of the device is registered but is required to update.

11. The method according to claim 9, wherein the step (a) includes:
aggregating the context; interpreting the context aggregated by comparing it with the context stored previously; and
selecting a target device that will receive the converted contents, using the interpreted context and extracting the characteristic value of the target device.

12. The method according to claim 9, wherein the step (a) includes the step of determining whether the context service is needed.
